(19) United States
(12) Patent Application Publication
(10) Pub. No.: US 2008/0047504 A1
(43) Pub. Date: Feb. 28, 2008

(54) FAN SHROUD RING AND METHOD FOR ITS MANUFACTURE

(76) Inventors: Guido Benvenuto, Lasalle (CA); Gerry Charette, Windsor (CA); Robert Desantis, Lasalle (CA)

Correspondence Address: GIFFORD, KRASS, SPRINKLE,ANDERSON & CITKOWSKI, P.C, PO BOX 7021, TROY, MI, 48007-7021, US

(21) Appl. No.: 11/832,775

(22) Filed: Aug. 2, 2007

Related U.S. Application Data
(60) Provisional application No. 60/821,148, filed on Aug. 2, 2006.

(51) Int. Cl. F01P 11/10; B29C 45/00; F04D 29/54

(52) U.S. Cl. 123/41.49; 165/51; 264/328.1; 415/173.6

(57) ABSTRACT

A fan shroud ring comprises a first member formed from a polymeric material and configured to be affixed to an internal combustion engine. The first member defines a central opening configured to have a fan associated with the engine project therethrough. The shroud ring includes a second member fabricated from an elastomeric material. The second member is bonded to the first member and encompasses at least a portion of the periphery of the first member. The elastomeric material may include a number of notches formed along its circumference. The notches allow for the flexing of the elastomeric material and thereby enhance the seal between the shroud ring and other components of a cooling system. The shroud ring may include integral stator blades for directing airflow and may also include mounting blocks and associated hardware. The fan shroud ring may be fabricated by an injection molding process.

### CROSS-REFERENCE TO RELATED APPLICATIONS

This application claims priority of U.S. Provisional Patent Application Ser. No. 60/821,148 filed Aug. 2, 2006, and entitled “Fan Shroud Ring and Method for Its Manufacture.”

### FIELD OF THE INVENTION

This invention relates generally to molded articles. More specifically, the invention relates to molded articles fabricated from a plurality of distinct materials, and to methods for their manufacture. Most particularly, the invention relates to a fan shroud ring intended for use as a component of an internal combustion engine.

### BACKGROUND OF THE INVENTION

Internal combustion engines, such as those used to power motor vehicles, generally require a cooling system for removing excess heat from the engine. Typically, the cooling system includes a radiator which circulates a coolant fluid through the engine, and a fan which directs an airflow through the radiator to enhance the cooling. Efficiency of the cooling process is important, particularly in applications involving high power engines such as diesel engines. In some instances, the cooling system includes a fan shroud which functions to encircle the cooling fan and more efficiently direct a stream of cool air across the radiator. In general, it is desirable that the fan and fan shroud be in close engagement so that air is efficiently directed through the radiator; and in this regard, the fan shroud often includes a ring member which functions to seal the space between the fan shroud and the fan. Problems can occur when engine torque or other extraneous forces displace the fan relative to the shroud and/or ring. Such displacement can cause the fan to strike either of these components causing damage.

As will be explained in detail hereinbelow, the present invention provides a fan shroud ring which is directly affixed to the engine, along with the fan, and as a consequence moves therewith thus preventing inadvertent contact between the fan and shroud components. Furthermore, the shroud ring of the present invention includes an integral elastomeric seal which provides for a tight connection between the shroud ring and the shroud thereby enhancing the efficiency of the cooling system. The fan shroud ring of the present invention is a composite member fabricated from a first, relatively rigid material, and a second, elastomeric material. As will be explained in detail hereinbelow, the present invention further provides a novel configuration for the components of the shroud ring, and further includes specific formulations of materials both of which will enhance the integrity of the device. The present invention also includes a novel method for the manufacture of the multi-component structure. These and other advantages of the invention will be apparent from the drawings and discussion which follow.

### BRIEF DESCRIPTION OF THE INVENTION

Disclosed herein is a shroud ring for a fan of an internal combustion engine. The ring comprises a first member formed from a polymeric material. The first member is configured to be affixed to an internal combustion engine and defines a central opening configured to have a fan associated with said engine project therethrough. The shroud ring further includes a second member fabricated from an elastomeric material. The second member is bonded to the first member and encompasses at least a portion of the periphery of the first member. The first member may, in particular embodiments, further define a plurality of stator ribs extending from the central opening to the periphery thereof. The stator ribs are operable to direct a flow of air passing thereacross. In particular instances, the elastomeric second member may encircle substantially all of the perimeter of the first member, and in particular embodiments may include one or more notches therein which extend from a free perimeter edge of the second member into the body thereof. The elastomeric material may be joined to the material of the first member by a stepped joint which functions to increase the contact area therebetween. Bonding agents may be used to enhance the bond between the two materials. In some instances, the elastomeric material may include a relatively small amount of either the first material or a material having similar physical properties. Inclusion of this material can enhance bonding. In specific instances, the polymeric material of the first member is nylon or polypropylene and may include a reinforcing material therein. The elastomeric material may comprise a synthetic rubber in particular instances.

In some instances, the fan shroud ring may be fabricated by an injection molding process wherein a first portion of the ring is molded in a first step of the molding process, and a second portion of the ring is molded thereonto in a second injection process. In a particular instance, the shroud ring can be fabricated in the molding apparatus which includes a mold cavity which defines the shroud ring. The molding apparatus further includes a movable blade member which can be positioned in the cavity so as to define a first portion of the cavity which corresponds to a first portion of the fan shroud ring. A polymeric material is injected into the first portion of the cavity, and thereafter the blade is displaced so as to expose a surface of the previously molded first portion. A second polymeric material is injected into the remaining portion of the cavity and forms a bond with the first polymeric material.

### BRIEF DESCRIPTION OF THE DRAWINGS

FIG. 1 is a perspective view of one embodiment of fan shroud ring in accord with the principles of the present invention;

FIG. 2A is a top plan view of the fan shroud ring of FIG. 1;

FIG. 2B is a cross-sectional view of the fan shroud ring of FIG. 2A taken along line A-A;

FIG. 3A is an enlarged, cross-sectional view of a portion of the fan shroud ring of FIG. 2A better illustrating the junction between the elastomeric material and rigid thermoplastic material;

FIG. 3B is an enlarged view of the shroud ring of FIG. 2A illustrating the stator structure thereof;

FIG. 4A is an enlarged view of a portion of the shroud ring of FIG. 2A showing the elastomeric member and notch structure;

FIG. 4B is an enlarged view of a portion of the shroud ring of FIG. 2A showing the mounting block; and

FIG. 5 is a perspective view of one particular embodiment of blade structure including integral cam surface, which blade may be utilized in an injecting molding process for the fabrication of the fan shroud ring.

### DETAILED DESCRIPTION OF THE PREFERRED EMBODIMENTS

The fan shroud ring of the present invention may be variously configured, and for purposes of illustration, one specific embodiment will be discussed. Referring now to FIG. 17 there is shown a fan shroud ring 10 in accord with the present invention. As shown, the ring 10 is a composite member having a first portion 12 formed from a relatively rigid material, which is typically a polymeric material. Such materials include high strength polymers, and one particular group of such high strength polymers comprises nylons. Polypropylene is another specific material which may be used in this invention. As is known in the art, the polymer material may include a reinforcing filler in the form of fibers, particles or the like. Such fillers can include glass, mica, carbon, other minerals, as well as polymeric materials. Mica-filled polypropylene is employed in specific high-temperature applications.

The shroud ring 10 further includes an elastomeric sealing portion 14 integrally bonded to the rigid portion 12. The sealing portion 14 forms an outer radius of the ring, and in use serves to engage further portions of the shroud assembly and provide a relatively tight gasket seal thereagainst. The elastameric portion 14 may be fabricated from synthetic or natural rubbers, as well as from other polymeric materials having sufficient resiliency and strength. One particular material having utility for the fabrication of the resilient portion 14 comprises a synthetic rubber sold by the Exxon Corporation under the designation Santoprene. As will be described in detail hereinbelow, the resilient material may be specifically formulated to provide good compatibility with the material comprising the rigid portion 12.

In use shroud ring 10 is fixedly mounted to the engine of a motor vehicle, and in this regard includes mounting blocks 16a, 16b, 16c, it being understood that a smaller or larger number of mounting blocks may be employed in other applications. Typically, the ring 10 is mounted onto the motor vehicle via bolts or other such fasteners which pass through the mounting blocks 16. Gaskets, seals, vibration-damping members or the like may be used in connection with the mounting; however, it is a notable feature of the present invention that such members need not be included, and the ring 10 is capable of being directly mounted onto the engine. The ring 10 is disposed so that the fan of the motor vehicle projects through the central opening 18 of the ring. The elastomeric portion 14 of the ring 10 contacts the remainder of the engine cooling shroud assembly and establishes a relatively airtight seal therebetween. It is another notable feature of the present invention that this resilient portion 14 includes a plurality of notches, such as notch 20 formed along the periphery thereof. These notches accommodate flexing and bending of the resilient member and enhance the integrity of the resultant seal. Since the shroud ring 10 is affixed to the vehicle's engine, displacement of the engine resultant from torque will move the shroud ring along with the engine and fan. The resilient portion 14 will serve to maintain contact with the remainder of the shroud assembly, despite the displacement of the fan, and the notches 20 will maintain the integrity of the seal. Also, the unitary motion of the ring and fan will prevent the fan from striking the ring, as is the case with prior art shroud assemblies.

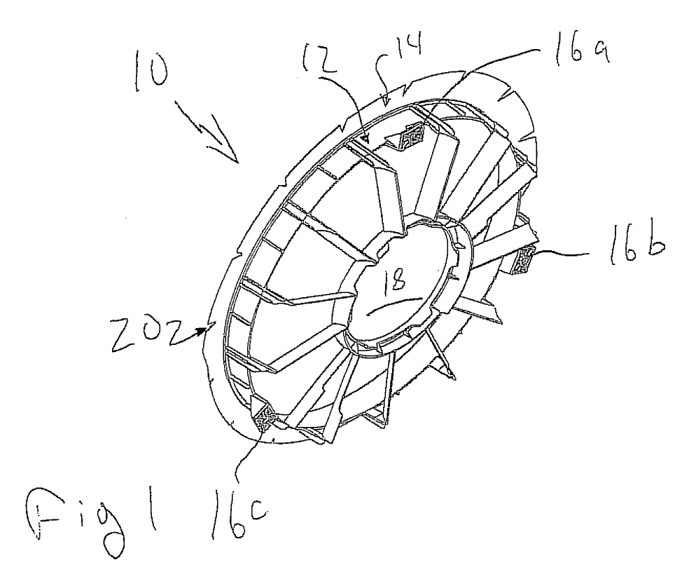

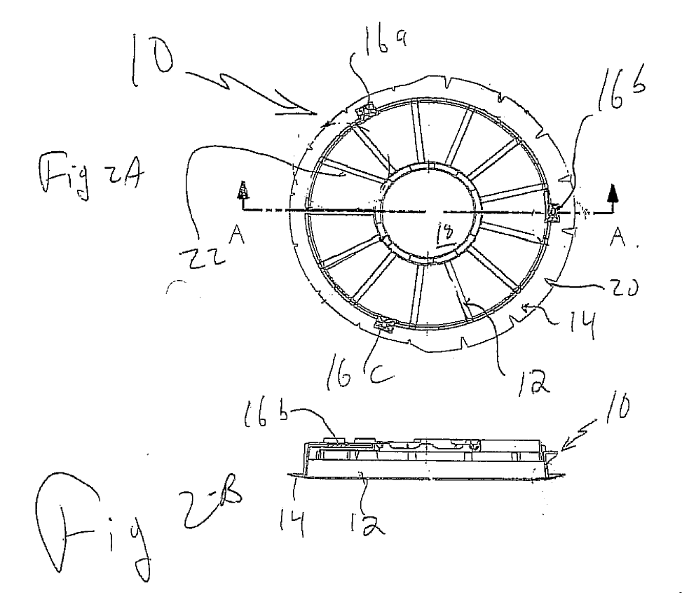

Referring now to FIG. 2A, there is shown a top plan view of the shroud ring 10 of FIG. 1. FIG. 2B is a cross-sectional view of the shroud ring 10 of FIG. 2A, taken along line A-A. Visible in both figures is the rigid portion 12, the resilient portion 14, the mounting blocks 16, and the notches 20, all as discussed above.

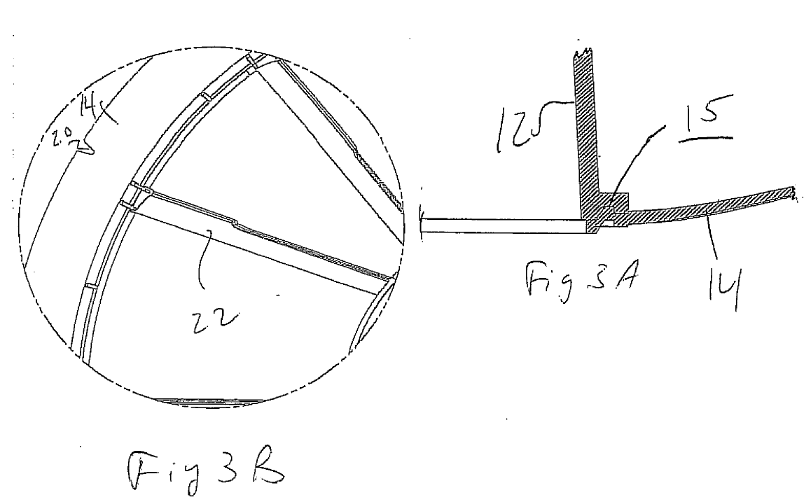

Referring now to FIGS. 3A and 3B, there are shown details C from FIG. 2A. These details comprise enlarged views of portions of the shroud ring 10. FIG. 3A is a cross-sectional view of a portion of the shroud ring of FIG. 2, and shows the junction between a sidewall segment of the rigid portion 12 and the resilient portion 14 of the shroud ring. As will be seen, the joint therebetween has a stepped configuration such that a portion of the resilient material 14 projects into a corresponding notch 15 in the rigid sidewall portion. This stepped structure increases the surface area between the two components and thereby enhances the integrity of the seal.

In specific instances, the materials comprising the rigid and resilient portions are selected to maximize compatibility between the two materials. For example, in one particular embodiment, the rigid portion is fabricated from a nylon polymer, and the resilient portion is fabricated from a thermoplastic elastomer (TPE) such as Santoprene sold by the Exxon Corporation. In accord with the present invention, it has been found that adhesion between the two materials, and hence the integrity of the seal, is enhanced in some instances if the thermoplastic elastomer is alloyed with a small amount of nylon, typically ranging up to 10%. Another material having physical properties similar to at least some of those of the nylon may be used in a similar manner to enhance bonding.

FIG. 3B is an enlarged view of the shroud ring of FIG. 2A and shows a segment of the resilient portion 14, better illustrating the notch 20. Also shown is a segment of the rigid portion specifically illustrating a stator rib, or fin, 22. As will be better seen in FIG. 2A, the shroud ring includes a plurality of such stator ribs, and these ribs may be angled to provide for direction of airflow through the shroud ring. They also provide structural rigidity to the unit.

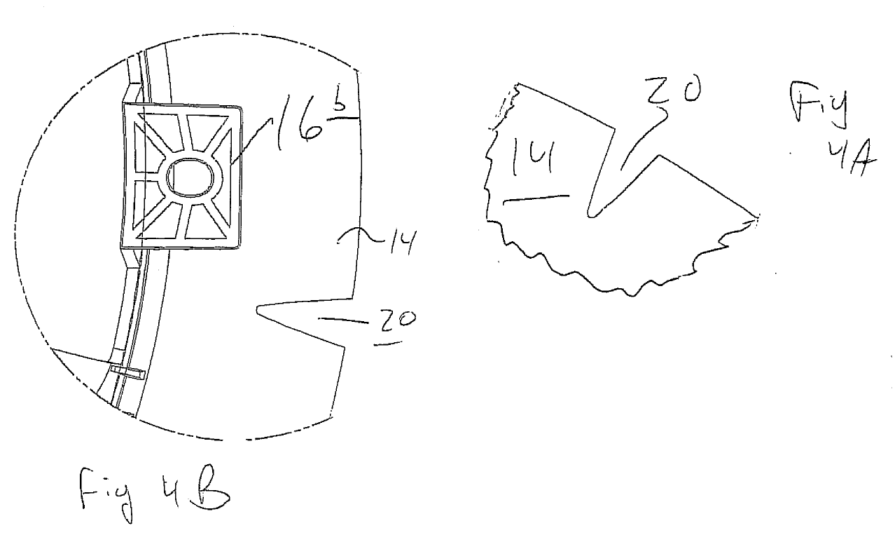

FIGS. 4A and 4B show enlarged portions of the shroud ring of FIG. 2A. Specifically, FIG. 4A provides an enlarged view of one of the notches 20 in the resilient portion 14. As noted, this notch reduces kinking and thereby accommodates flexing and bending of the resilient body when the shroud ring is engaged with the remainder of the shroud assembly. FIG. 4B is an enlarged view of one of the mounting blocks 16b. As will be seen, the block is configured to accommodate a mounting bolt or other such hardware.

The shroud ring of the present invention may be fabricated through a variety of processes. One specific group of fabrication techniques comprises injection molding. In one instance, a two-shot injection molding process may be used to fabricate the shroud ring. In a process of this type, a first portion of the shroud ring, such as the rigid portion, is formed by injection of a first polymeric material into a molding system; and thereafter, the second portion, for example the elastomeric portion, is then molded onto the first by injecting the second material into the molding apparatus so that this material contacts the first portion which was previously molded, and bonds thereto. There are a number of techniques for implementing such two-shot molding processes. In one method in accord with the present invention, the first material is molded into a mold cavity, which cavity includes a movable blade member which can, in a first position, be disposed so as to occlude a portion of the mold cavity thereby restricting the injected first body of material to a first area of the cavity. Following this first injection, the movable member is displaced so as to open a second portion of the mold cavity, which portion is configured to receive the second injected polymeric material. Referring back to FIG. 3A, it is to be noted that the notch 15 in the rigid portion 12 defining the stepped joint may, in one molding process, be defined by a displaceable ring member which, in its first position, configures the notch. This ring is subsequently displaced in a downward direction relative to FIG. 3 so as to allow access of the elastomeric material comprising the second portion 14. It will be noted from FIG. 3 that the underside of the second portion 14 includes a slight notch, and this is an artifact of the presence of the displaceable blade.

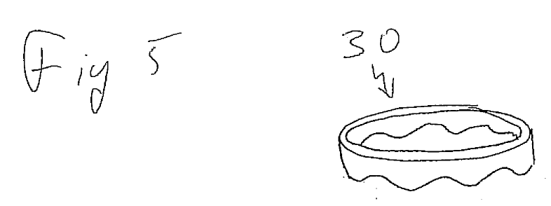

In one particular embodiment of apparatus used for a two-shot molding process for the fabrication of the aforedescribed shroud ring, the molding apparatus includes a retractable, ring-shaped blade having an upper surface which provides the aforedescribed occluding function and a lower surface which is a camming surface. By use of an appropriate cam linkage, it will be understood that this ring may be reciprocated in an upward and downward direction so as to accommodate the molding process. FIG. 5 is a perspective view of the aforedescribed blade structure 30.

The structures of the present invention may be prepared by other processes. Such processes may include transfer molding wherein a first portion of the component is manufactured in a first molding station and then transferred to a second molding station wherein the second portion is molded thereonto. These molding stations may be in a single apparatus or in separated apparatus. Another method could comprise rotational molding wherein a molding apparatus rotates between separate stations wherein portions of the component are molded thereonto. In yet other instances, components may be assembled via adhesives, ultrasonic welding, thermal bonding or the like to prepare the composite structure. All of such embodiments are within the scope of this invention.

In view of the foregoing, it is to be understood that numerous modifications and variations of the present invention may be implemented by those of skill in the art. In that regard, the shroud ring assembly may include further portions formed from rigid or elastomeric material thereupon. Likewise, the overall size or shape of the ring may be varied to accommodate particular applications. Likewise, fabrication processes other than those specifically disclosed herein may be readily implemented by those of skill in the art. Therefore, it is to be understood that the foregoing drawings, discussion and description are illustrative of specific embodiments of the invention, but are not meant to be limitations upon the practice thereof. It is the following claims, including all equivalents, which define the scope of the invention.

1. A fan shroud ring, said ring comprising:
a first member formed from a polymeric material, said first member configured to be affixed to an internal combustion engine, said first member defining a central opening configured to have a fan associated with said engine project therethrough; and
a second member fabricated from an elastomeric material, said second member being bonded to said first member, and encompassing at least a portion of the periphery of the first member.

2. The shroud ring of claim 1, wherein said first member further defines a plurality of stator ribs extending from said central opening to the periphery thereof, said stator ribs being operable to direct a flow of air passing thereacross.

3. The shroud ring of claim 1, wherein said second member encircles substantially all of the perimeter of said first member.

4. The shroud ring of claim 1, wherein said second member includes a notch defined therein, said notch extending from a free perimeter edge of said second member into the body thereof.

5. The shroud ring of claim 1, wherein at least one of said first and second member is formed by injection molding.

6. The shroud ring of claim 5, wherein both of said first and second members are formed by injection molding.

7. The shroud ring of claim 6, wherein said first and second members are formed in a two-shot injection molding process wherein said first member is bonded to said second member.

8. The shroud ring of claim 7, wherein said two-shot injection molding process utilizes a retractable blade which is movable from a first position in which a polymeric material is injected into a mold cavity to form the first member, to a second position in which polymeric material is injected into the mold cavity to form the second member.

9. The shroud ring of claim 1, wherein said first and second members are joined together via a stepped joint.

10. The shroud ring of claim 1, wherein the material comprising at least one of said first and second member includes an additional agent therein which fosters bonding of said first member to said second member.

11. The shroud ring of claim 10, wherein the elastomeric material of said second member is alloyed with a material which fosters the bonding of said second member to said first member.

12. The shroud ring of claim 11, wherein said material which fosters bonding comprises a polymeric material which is similar in at least some physical properties to that used to fabricate said first member.

13. The shroud ring of claim 1, wherein said first polymeric material is a nylon or polypropylene.

14. The shroud ring of claim 1, wherein said elastomeric material comprises a synthetic rubber.

15. A cooling assembly for a motor vehicle, said cooling assembly including the shroud ring of claim 1.

16. A method for fabricating a fan shroud ring, said method comprising:
providing an injection molding apparatus having a mold cavity therein, said apparatus including a blade which is displaceable from a first position wherein it separates a first portion of said mold cavity from a second portion of said cavity, to a second position wherein it does not separate said first portion of said cavity from said second portion;
disposing said blade in said first position;
injecting a first polymeric material into said cavity so as to form a first portion of said shroud ring;
displacing said blade from said first position to said second position; and
injecting a second polymeric material into said cavity so as to form a second portion of said shroud ring; whereby said first portion is bonded to said second portion.
